(19) United States
(12) Patent Application Publication
(10) Pub. No.: US 2023/0037769 A1
(43) Pub. Date: Feb. 9, 2023

(54) Self Charging Solar Phone (SCSP)

(71) Applicant: Ramon Flores, JR., Rosenberg, TX (US)

(72) Inventor: Ramon Flores, JR., Rosenberg, TX (US)

(21) Appl. No.: 17/453,236

(22) Filed: Nov. 2, 2021

Related U.S. Application Data
(60) Provisional application No. 63/230,859, filed on Aug. 9, 2021.

(51) Int. Cl. H04M 1/02; H02S 40/38; H02J 7/35; H02S 10/40

(52) U.S. Cl. CPC H04M 1/0202; H02S 40/38; H02J 7/35; H02S 10/40

(57) ABSTRACT

SCSP is a basic mobile phone with added feature . . . SOLAR CHARGING MODE. For when needing or wanting to charge device during daylight hours. Eliminates having to use “already existing” built-in charging port when no source of electrical power is available or nearby. Example use: When enjoying out-door activities such as fishing, hiking, exercising or just normal everyday device use. Also convenient when out with family and/or friends at an Amusement Park, Zoo, Baseball game or at the Beach; things of that nature. Device will have same normal functions, power ON/OFF button, volume UP/DOWN buttons, “Bixby button” (optional). Headphone port, charging port “for night-time use”. Reset port, and S-Pen “stylus pen” (optional). Camera(s), light, fingerprint sensor and speakerphone. Added feature will be the solar screen/glass/film built-in on the front and back of device. Included is Safety Automatic “shut-off” built-in so device will not over charge, and is Water Proof. How to operate Solar Charge/Charging is either by touch screen “just like turning on/off flashlight on phone” and a ON/OFF solar charge button located directly underneath device ON/OFF button that can be pressed and Solar Charge option will be displayed on device “front” screen. I Ramon Flores Jr. claim to be the inventor of the SCSP (Self Charging Solar Phone).

### SPECIFICATION

I Ramon Flores Jr. have invented the SCSP (Self Charging Solar Phone). A new feature for a mobile cellular phone, as set forth in the following specification. The claimed mobile cellular phone is rechargeable using solar power during (daytime/outdoor) use and can be used on the go daily.

### DESCRIPTION SPECIFICATION

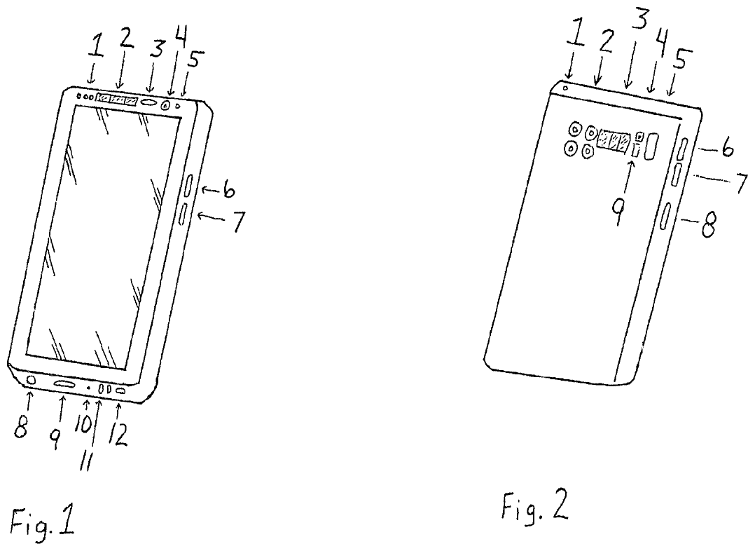

FIG. 1 is a front, right and bottom angle view of a mobile cellular phone showing my new feature. In FIG. 1 Element 1 corresponds to indicator lights. Element 2 corresponds to solar glass/film. Element 3 corresponds to ear speaker. Element 4 corresponds to front facing camera. Element 5 corresponds to ambient light sensor. Element 6 corresponds to ON/OFF button. Element 7 corresponds to solar button. Element 8 corresponds to headphone port. Element 9 corresponds to charging port. Element 10 corresponds to bottom micro phone. Element 11 corresponds to speakerphone and Element 12 corresponds to S-Pen “stylus pen” which is optional.

FIG. 2 is back, left and top angle view thereof. In FIG. 2 Element 1 corresponds to top microphone. Element 2 corresponds to cameras. Element 3 corresponds to solar glass/film. Element 4 corresponds to flashlight. Element 5 corresponds to fingerprint sensor. Element 6 corresponds to volume up. Element 7 corresponds to volume down. Element 8 corresponds to bixby (optional) and Element 9 corresponds to heart rate monitor.

1. I Ramon Flores Jr. claim that I am the inventor of the SCSP (Self Charging Solar Phone) by filing a provisional application prior to filing the nonprovisional utility application. Provisional application No. 63/230,859 filing date Aug. 9, 2021
